(19) United States
(12) Patent Application Publication
(10) Pub. No.: US 2015/0013618 A1
(43) Pub. Date: Jan. 15, 2015

(54) Compliant Squeeze Chute Mechanism

(71) Applicant: Jon Davis Mollhagen, Lorraine, KS (US)

(72) Inventor: Jon Davis Mollhagen, Lorraine, KS (US)

(21) Appl. No.: 14/328,099

(22) Filed: Jul. 10, 2014

Related U.S. Application Data
(60) Provisional application No. 61/844,622, filed on Jul. 10, 2013.

(51) Int. Cl. A01K 1/06

(52) U.S. Cl. CPC A01K 1/0613
USPC 119/752

(57) ABSTRACT

An improved squeeze chute provides compliance between the side gates or side panels of the squeeze chute. Squeeze chutes generally include pivoting side panels that move between an open position and a closed position. A hydraulically driven rock shaft assembly is rotated by an actuator and is connected by linkages to the upper ends of the pivoting side panels. Compliance in the closing action of the panels is provided by interposing a compliant torsion assembly between the actuator and the rock shaft. The compliant torsion assembly has a first portion that surrounds the rock shaft and a second portion which surrounds the first portion. Elastic elements are interposed between the first portion and the second portion. A tab extends from the second portion to which one end of the actuator is attached. The other end of the actuator is attached to the frame of the squeeze chute.

### CROSS REFERENCES TO RELATED APPLICATIONS

This application claims the benefit of U.S. Provisional Patent Application Ser. No. 61/844,622 filed on Jul. 10, 2013 which is incorporated herein by reference.

### FIELD OF THE INVENTION

The present invention relates to a squeeze chute in which compliance has been introduced between the actuator and the side gates or side panels.

### BACKGROUND OF THE INVENTION

Typical squeeze chutes include side panels that are known in the industry as “side gates” which are arranged much like a clam shell mechanism. The lower ends of the side panels are pivotably mounted to the squeeze chute frame for movement between an open position in which the upper ends of the side panels are widely spaced and a closed position in which the upper ends of the side panels are less widely spaced. When an animal is introduced into the squeeze chute, the side panels are usually in the open position. The operator activates an actuator and the side panels move together and restrain the animal and by doing so sets the spacing between the side panels. With a typical prior art squeeze chute, this spacing is essentially rigid. If the spacing is set to narrow, the animal may be unnecessarily uncomfortable. If the spacing is set too wide, the animal may be able to move too easily. In many cases, the operator may have to adjust the spacing more than once to accommodate the animal or appropriately restrain the animal. This waste valuable time during what is probably a stressful procedure that should be accomplished as quickly as possible.

### SUMMARY

The above described problem in this example, is addressed by a squeeze chute that includes a compliant torsion assembly interposed between the actuator and the mechanism which moves the side panels between the open position and the closed position. Squeeze chutes generally include pivoting side panels that move between an open position and a closed position. A rock shaft assembly is rotatably mounted to the squeeze chute frame and is connected by linkages to the upper ends of the pivoting side panels. An actuator connects between the squeeze chute frame and the rock shaft. In this embodiment, compliance in the closing action of the panels is provided by interposing a compliant torsion assembly between the actuator and the rock shaft. In this example, the compliant torsion assembly includes a first portion that surrounds the rock shaft and a second portion that surrounds the first portion. Elastic elements are positioned between the first portion and the second portion. A tab extends from the second portion to which one end of the actuator is attached. The other end of the actuator is attached to the squeeze chute frame. When the actuator is activated, the side panels move together but when the side panels encounter resistance, typically by making contact with an animal, such as a steer or a heffer, the compliant torsion assembly deflects thereby providing compliance between the panels when the animal is squeezed in the squeeze chute.

### BRIEF DESCRIPTION OF THE DRAWINGS

FIG. 1 is an end view of one embodiment of a squeeze chute that includes a torsion assembly.

FIG. 1A is an end view of one embodiment of a a squeeze chute which includes a compliant torsion assembly showing the side panels in the open position.

FIG. 1B is an end view of one embodiment of a a squeeze chute which includes a compliant torsion assembly showing the side panels in the closed position.

FIG. 2 is a perspective view of one embodiment of a a squeeze chute that includes a torsion assembly.

FIG. 3 is a perspective view showing one embodiment of the rock shaft assembly.

FIG. 4 is an enlarged perspective view of one embodiment of the torsion assembly.

FIG. 4A is an enlarged exploded perspective view of one embodiment of the torsion assembly.

### DETAILED DESCRIPTION

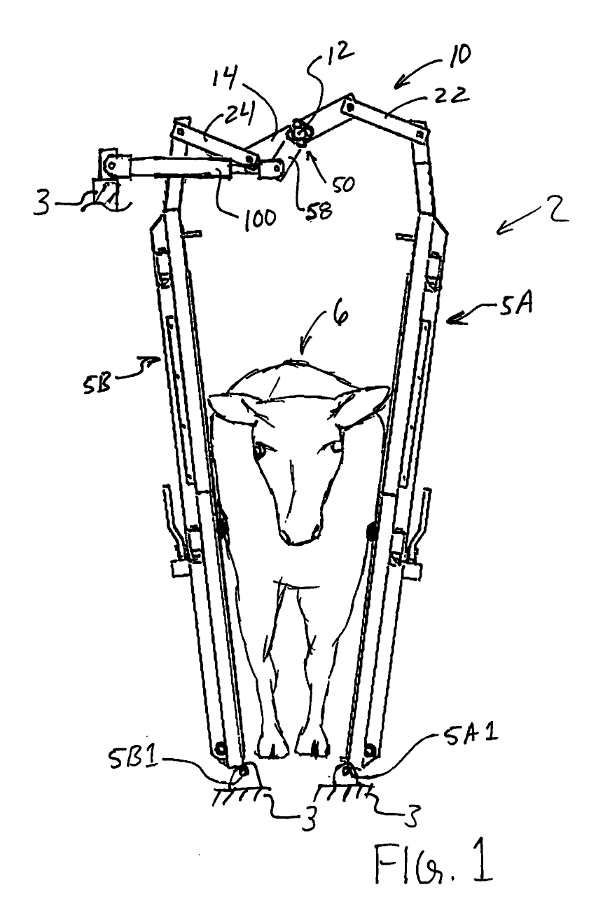

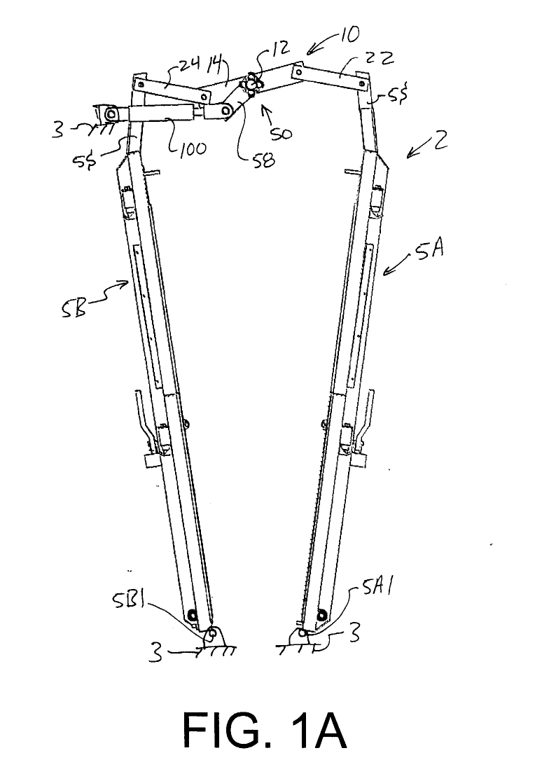

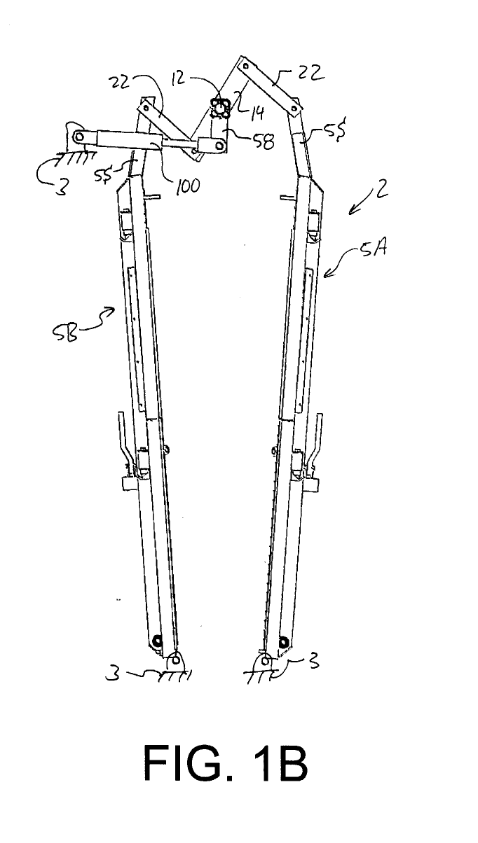

Referring to the drawings, FIG. 1 shows one embodiment of a squeeze chute 2 that includes a frame 3, side panels 5A and 5B and a rock shaft mechanism 10. As can be seen in FIG. 1, side panels 5A and 5B are preferably pivotably mounted to frame 3 at pivot joints 5B1 and 5B2 respectively. As can be seen in FIG. 1, panels 5A and 5B define a chute through which a livestock animal 6 may pass.

As can be seen in FIGS. 1 and 2, in this example, rock shaft mechanism 10 includes a rock shaft 12, center linkages 14, side linkages 16, a compliant torsion assembly 50 and an actuator 100. Rock shaft 12 is preferably oriented generally longitudinally at the upper end of squeeze chute 2 and is mounted to frame 3 by bearings 12A at opposite ends (one bearing 12A at one end is shown in FIG. 2). Bearings 12A permit the rotation of rock shaft 12 relative to frame 3. Center linkages 14 are fixed to rock shaft 12 and extend on either side of rock shaft 12. In this example, side linkages 16 pivotably connect between the distal ends of center linkages 14 and stantions 5S that extend from the upper ends of side panels 5A and 5B. As can be seen by referring to FIGS. 1A and 1B, when rock shaft 12 is rotated, center linkages 14 rotate, which, in turn, causes opposite lateral movements of the upper ends of side panels 5A and 5B. It is this action that makes it possible to adjust the spacing between side panels 5A and 5B between an open position shown in FIG. 1A and a closed position shown in FIG. 1B. This mechanism is generally similar to that employed by prior art squeeze chutes as exemplified by the squeeze chute taught in U.S. Pat. Nos. 5,331,923 and 6,425,351, which name the applicant as the sole inventor and which are incorporated herein by reference.

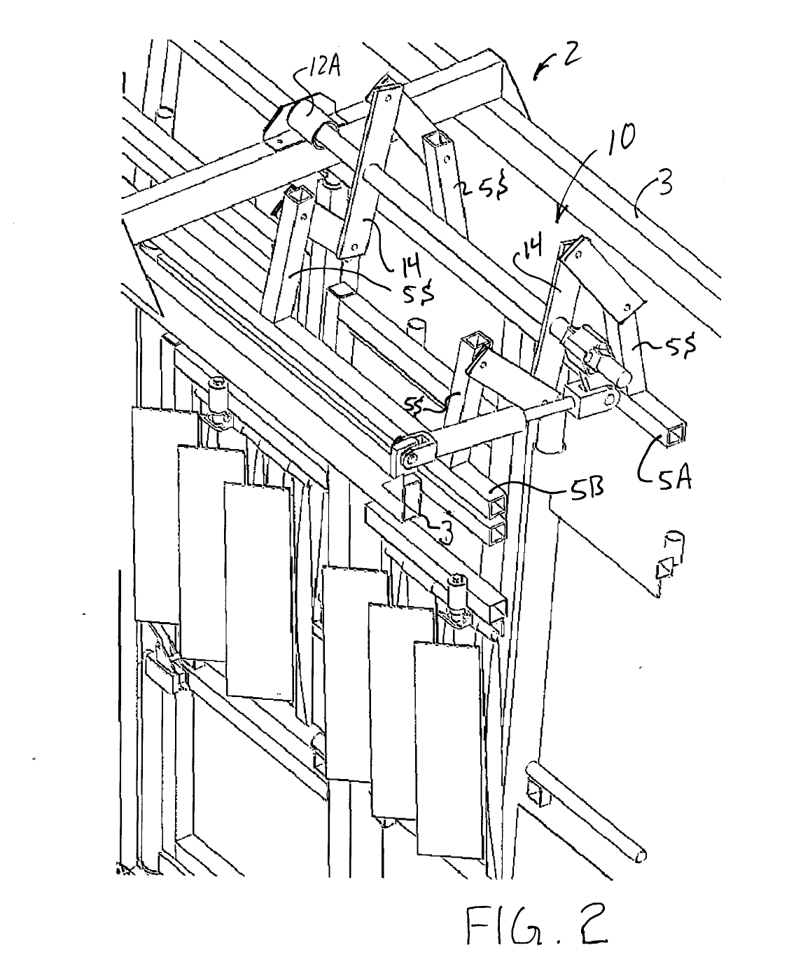

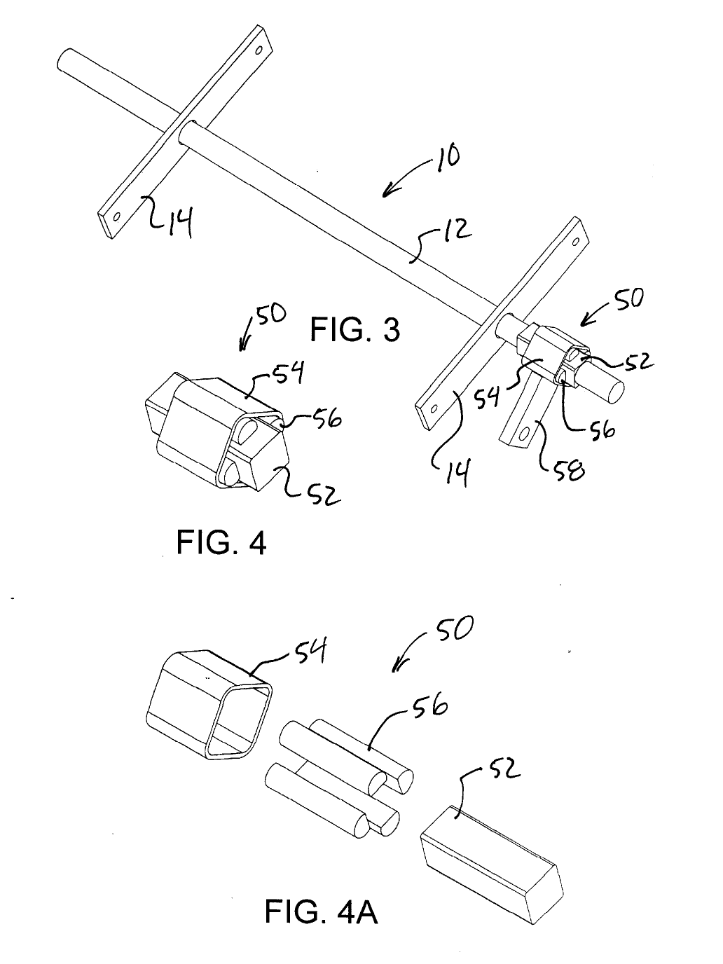

The rotation of rock shaft 12, which causes the opening and closing of side panel 5A and 5B as noted above, is, in this example, powered by actuator 100. In this example, actuator 100 is a typical double action hydraulic cylinder. However, actuator 100 may be replaced by any one of a number of suitable linear actuators. The applicant has found that hydraulic cylinders provide the most practical, responsive and cost effective means for actuating a rock shaft assembly. As can be best seen in FIG. 3, actuator 100 connects between frame 3 and a tab 60 that is fixed to a compliant torsion assembly 50. Compliant torsion assembly 50 is interposed between actuator 100 and rock shaft 12.

Compliant torsion assembly 50 is shown in greater detail in FIGS. 3, 4 and 4A. As can be best seen in FIGS. 4 and 4A, compliant torsion assembly 50, in this example, includes a first portion 52, a second portion 54 and four elastic elements 56. In this example, first portion 52 is a tube segment or bar segment having a square cross section which presents four flat sides 52A. First portion 52 is preferably fixed to and aligned with rock shaft 12. In this example, second portion 54 is in the form of a generally square tube which, in this example has rounded corners 54A. Second portion 54 is preferably sufficiently large such that when it is clocked 45 degrees relative to first portion 52, the inside surfaces of the square tube of second portion 54 clear the corner edges of first portion 52. In this example, four elongated elastic elements 56 are inserted between flat sides 52A of first portion 52 and the inside surfaces of rounded corners 54A of second portion 54. In this example, first portion 52 and second portion 54 have square cross sections, but other shapes could be chosen for first portion 52 and second portion 54. Preferably, first portion 52 and second portion 54 (as well as most of the other components described above) are fashioned from a strong, rigid material such as steel. Elastic elements 56 are preferably fashioned from a tough foam rubber material which is resilient but suitably resistant to forces so that significant torque may be applied through it. In this example each elastic element 56 is generally cylindrical in shape but has one flat side 56A that fits against a corresponding flat side of first portion 52. This shape provides gradually increasing resistance when torque is applied to compliant torsion assembly 50.

In this example, for use with average sized cattle, compliant torsion assembly 50 works best if one foot pound of torque between first portion 52 and second portion 54 initially causes approximately 0.1 to 0.6 degrees of rotation between first portion 52 and second portion 54 with 0.3 degrees of rotation in response to one foot pound of torque being preferable. As can be seen in FIG. 3, a tab 58 is fixed to one of the sides of second portion 54, and, as can be seen in FIG. 1, one end of actuator 100 is connected to tab 58 with the other end of actuator 100 being connected to frame 3. Accordingly, compliant torsion assembly 50 is interposed between actuator 100 and rock shaft 12, and by extension between actuator 100 and side panels 5A and 5B. When the operator activates actuator 100 and when side panels 5A and 5B contact animal 6 as shown in FIG. 1, the panels are not set in contact with animal 6 in a rigid fashion but in a compliant fashion. Thus, the animal is squeezed not in a harsh, unyielding mechanical fashion, but in a way that is more natural and yielding. This is more comfortable for the animal and easier for the operator.

It is to be understood that while certain forms of this invention have been illustrated and described, it is not limited thereto, except in so far as such limitations are included in the following claims and allowable equivalents thereof

Having thus described the invention, what is claimed as new and desired to be secured by Letters Patent is:

1. A squeeze chute, comprising:
(a) a frame having an upper end and a lower end,
(b) a pair of spaced side panels having lower ends and upper ends, the lower end of each side panel pivotably mounted to the lower end of the frame such that each side panel is operable for pivoting between an open position in which the upper ends of the side panels are widely spaced apart and a closed position in which the upper ends of the side panels are less widely spaced apart,
(c) a rock shaft assembly rotatably mounted to the upper end of the frame operable for rotation between a first position and a second position,
(d) linkages connecting between the rock shaft assembly and the upper ends of the side panels such that when the rock shaft is rotated to the first position, the side panels are in the open position and such that when the rock shaft is rotated to the second position, the side panels are in the closed position,
(e) a compliant torsion assembly mounted to the rock shaft having a first portion fixed to the rock shaft, a second portion spaced away from the rock shaft and an elastic element interposed between the first portion and the second portion,
(f) an actuator connecting at least indirectly between the frame and the second portion of the torsion assembly, the actuator operable for movement between a first position and a second position, such that, the rock shaft is in the first position when the actuator is in the first position, and, when the compliant torsion assembly is encountering substantially no mechanical resistance, the rock shaft is in the second position when the actuator is in the second position,
whereby, when the actuator is activated to move the side panels from the open position toward a closed position in order to restrain a livestock animal positioned between the side panels, the side panels being compliant when applying side forces to the livestock animal as the compliant torsion assembly provides compliance between the side panels and the frame such that breathing and limited movement of the animal is facilitated.

2. The squeeze chute of claim 1, wherein:
the compliant torsion assembly includes a first portion which is fixed to the rock shaft and which has a polygonal cross section presenting generally flat outside surfaces which intersect at a plurality of edges and a second portion which is a corresponding polygonal tube presenting generally flat inside surfaces, the second portion of sufficient size such that the inside surfaces of the second portion will receive the edges of the first portion thereby defining elongated spaces between the first portion and the second portion and a plurality of elastic members inserted in the elongated spaces between the first portion and the second portion, whereby rotation of the second member relative to the first member is resisted by the elastic members.

3. The squeeze chute of claim 2, wherein:
the first portion and the second portion have rectangular cross sections.
